(19) United States
(12) Patent Application Publication
(10) Pub. No.: US 2006/0242401 A1
(43) Pub. Date: Oct. 26, 2006

(54) Recognition of devices connected to a console server

(75) Inventors: Jan Elliger, Minnetonka, MN (US); Ben Tucker, Bloomington, MN (US)

Correspondence Address: Schwegman, Lundberg, Woessner & Kluth, P.A., P.O. Box 2938, Minneapolis, MN, 55402, US

(73) Assignee: Digi International Inc.

(21) Appl. No.: 11/112,146

(22) Filed: Apr. 22, 2005

(51) Int. Cl. G06F 9/00; G06F 15/177

(52) U.S. Cl. 713/2

(57) ABSTRACT

This document discusses, among other things, methods including recording in a first port log information received through a first port on a console server from a device that is connected to the first port, executing instructions that read the information in the port log and processing the information in the port log to determine information about the device. An example console server includes a port connectable to a device through a serial connection, a network connection in communication with the port, a processor circuit in communication with the port; and a memory circuit embodying executable instructions operable on by the processor, including instructions that acquire information from a device connected to the port during a device boot sequence, determine information about the device from the information acquired from the device, and apply settings to the port based upon the information determined about the device.

### TECHNICAL FIELD

This patent document pertains generally to console servers, and more particularly, but not by way of limitation, to recognition of devices connected to a console server.

### BACKGROUND

Console servers provide remote access to data equipment. A console server typically includes a network connection and several serial ports. A device such as a server, router, switch, private branch exchange (PBX), firewall, or other network device is connected to the console server through a serial port. The device is accessible through the console server via the network connection. In an example, the network connection is an Ethernet port, a wireless network connection that connects the console server to a TCP/IP network, the internet, or a dial-up modem connection. In one approach, communications with the console server are encrypted to provide secure access to a server, for example.

When a device is connected to a console server, a human system operator typically identifies and records the connected devices and applies port settings to ports to which devices are connected. Some console servers include as many as 64 ports or more.

### SUMMARY

According to one method, devices connected to a console server are recognized by recording in a port log information received through a port on the console server, executing instructions that read the information in the port log and processing the information in the port log to determine an assigned name of the device and an operating system that is running on the device.

According to another method, console server ports to which devices are connected are configured by determining an operating system running on a device connected to a port of a console server, sending a probing transmission associated with the operating system through the port, receiving a response to the probing transmission, determining information about the operating system from the response to the probing transmission, identifying at least one port setting that is a function of at least one aspect of the information about the operating system determined from the response to the probing transmission, and applying the at least one port setting to the port.

In one example approach, a console server includes a port connectable to a device through a serial connection, a network connection in communication with the port, a processor circuit in communication with the port, and a memory circuit embodying executable instructions operable on by the processor, including instructions that acquire information from a device connected to the port during a device boot sequence, determine information about the device from the information acquired from the device, and apply settings to the port based upon the information determined about the device.

According to yet another method, devices connected to a console server are recognized by acquiring from a device connected to a first port on a console server port a first set of data, determining from the first set of data information about the device including the identity of the device, and storing in a memory circuit information about port settings applied to the first port. If the device is disconnected from the first port and connected to a second port on the console server, a second set of data is acquired from the device through the second port, information about the device including the identity of the device is determined from the second set of data, the information about the port settings applied to the first port is retrieved from the memory circuit, and at least one of the port settings applied to the first port is applied to the second port.

### BRIEF DESCRIPTION OF THE DRAWINGS

FIG. 1 is a flowchart that illustrates a method that includes determining information about a device from a port log.

FIG. 2 is a schematic illustration of a console server.

FIG. 3 is a schematic illustration of a terminal connected to a console server through a network, and components connected to the console server.

FIG. 4 is a flowchart that illustrates a method that includes sending a probing character or sequence associated with an operating system and determining information about the operating system from the response.

FIG. 5 is a flowchart that illustrates a method that includes sending a probing character and analyzing a response.

FIG. 6 is a flowchart that illustrates a method that includes recognizing connection of a device to a second port and copying first port settings to the second port.

FIG. 7 is a schematic illustration of a plurality of console servers connected through a network.

### DETAILED DESCRIPTION

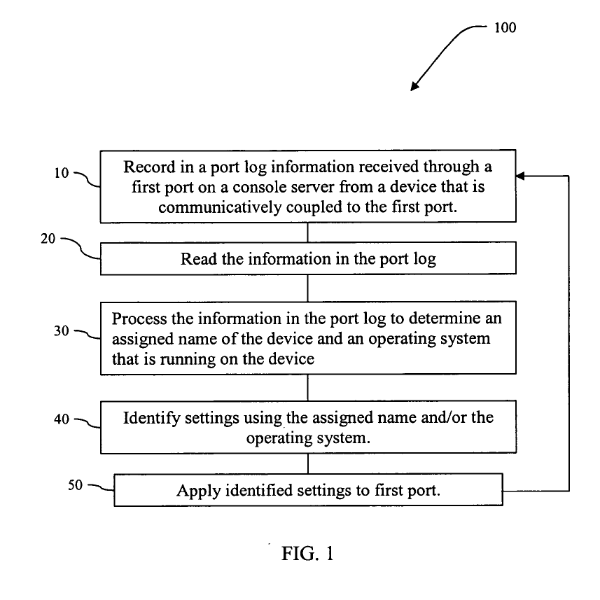

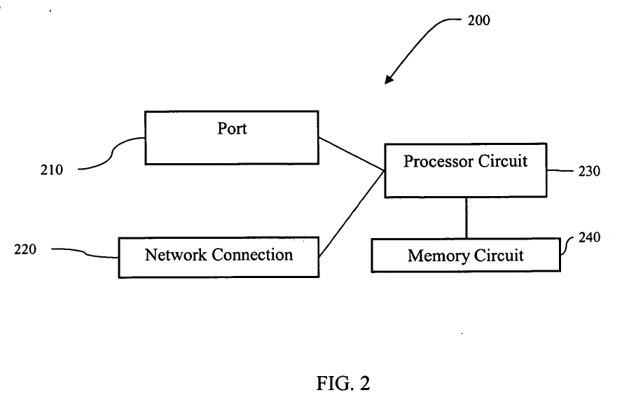

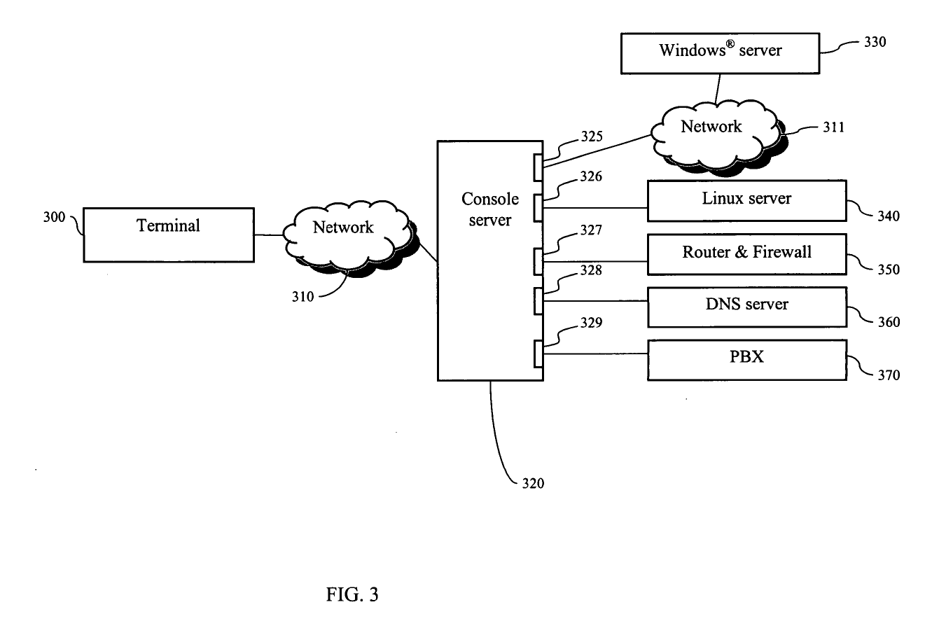

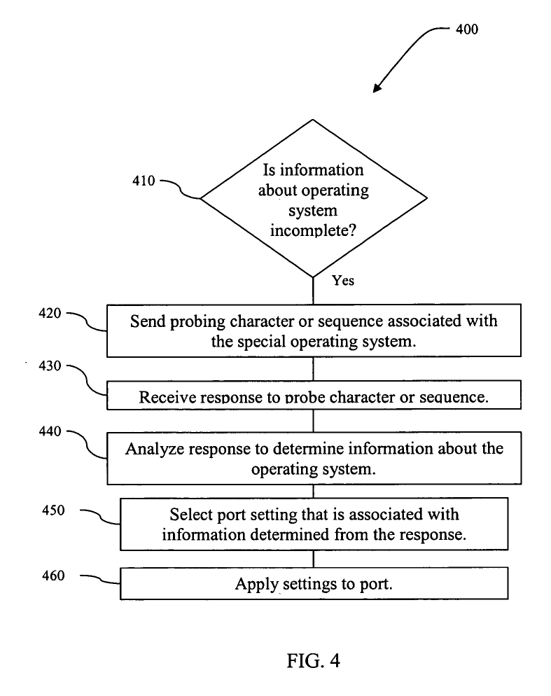

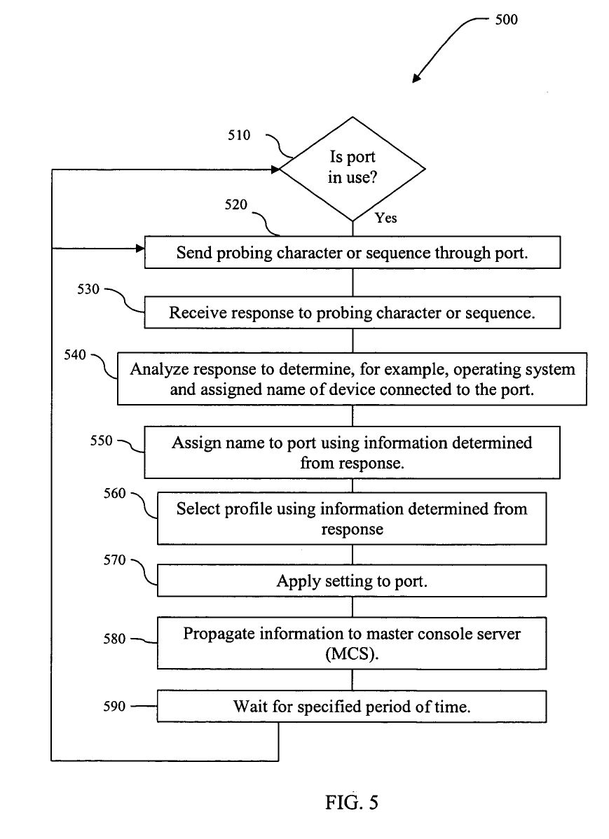

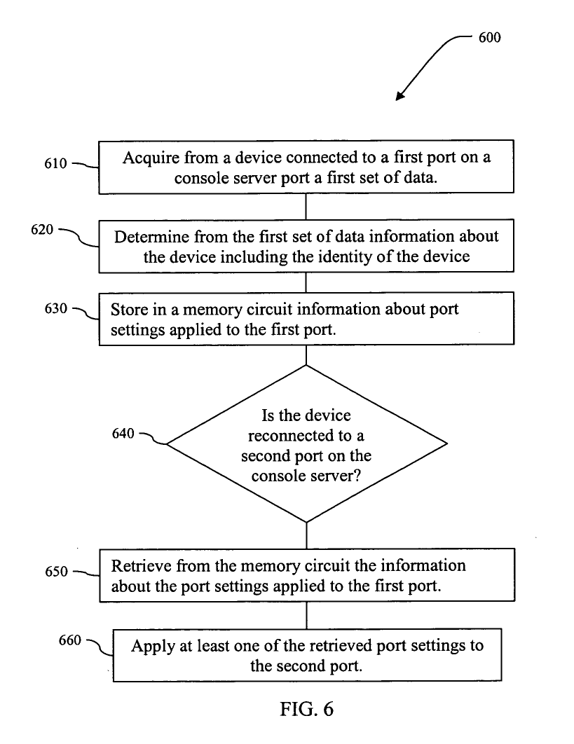

A device connected to a console server is recognized using information obtained through a port to which the device is connected. In an example, the console server “passively” examines a connected device by examining information in a port log. In the example illustrated in FIG. 1, for example information such as the name of the device or the operating system running on the device is determined from information in a port log. A schematic illustration of an example console server is provided in FIG. 2. FIG. 3 shows a console server connected to several devices. In another example, the console server “actively” examines a connected device by sending a probing character or string and examining a response. A flowchart illustrating a method that includes sending a probing character or sequence associated with an operating system is provided in FIG. 4. FIG. 5 is a flowchart that illustrates a method in which a profile is identified using a response to a probing character or sequence. In an example, a console server port is dynamically reconfigurable using information obtained from a port log, or from a response to a probing character or string. Port settings, optionally specified by a profile, are applied to the port based upon information that is determined about the port. In the example illustrated in FIG. 6, a device previously connected to a first port is recognized at a second port, at least one port setting from the first port is applied to a second port. In some examples, automated recognition of devices and/or configuration of ports speeds up the initial configuration of a console server and/or reduces administrative overhead associated with managing the console server.

Referring now to the example method 100 illustrated by the flowchart in FIG. 1, at 10 information received through a port on a console server from a device that is communicatively coupled to the port is recorded in a port log. In an example, the device is physically connected to the port, for example with a serial cable. In another example, the device is connected to the port through a network connection, such as a LAN network, the internet, and/or a wireless network. In an example, a boot sequence is recorded in the port log. At 20, information, such as the boot sequence, is read from the port log. At 30, information from the port log is processed to determine information about the device, such as the assigned name (hostname) of the device, and an operating system (e.g. WINDOWS, CISCO IOS, SUN Solaris, LINUX) that is running on the device. In another example, the type of device (e.g. SUN) or the location of the device is determined from the port log. In an example, a script is run that determines the name of the device and the operating system. In an example, the script determines not only the operating system, but also the version number of the operating system (e.g. WINDOWS Server 2003). In an example, the script is user-configurable. In an example the script uses standard bash commands and writes output to one or more files.

Returning to FIG. 1, at 40, information about the device, such as the assigned name and/or the operating system, is used to identify port settings. In an example, a settings profile is identified. In an example, the profile is associated with the assigned name of the device and/or the operating system of the device. At 50, identified settings are applied to the port. In an example, the settings are specified by a profile. In an example, a port name is assigned to the port such as main-router. In an example, the assigned port name provides information about the device that is connected to the port, such as the assigned name of the device and the operating system that is running on the device. In an example, a user access setting is applied to the port. An example user access setting applied to a port allows only specified users access to a device. In an example, user access is controlled by device, device type, or operating system (e.g. only administrators are allowed access to devices having a certain operating system.) In another example, an alert setting controls a recipient list for alerts relating to the port. In an example, operators or administrators of a specific operating system are sent an alert relating to a device running the specific operating system.

In an example, the port log is periodically examined to identify changes in the connected device or the operating system running on the connected device. In an example, the timing of the periodic examination of the port log is user-configurable. In an example, the port log is examined every five minutes. In an example, the console server waits an amount of time and examines the port log again to confirm the change and avoid erroneous setting change. If a change is confirmed, port settings and/or the port name are updated. In another example, the port log is examined when a device is connected or disconnected to the port. In an example, the ports of a console server are dynamically reconfigurable as the connection of devices to ports is changed. For example, if cables are mixed up after disconnecting and reconnecting devices, an example console server automatically updates port names and/or port settings.

Referring now to FIG. 2, a schematic illustration of an example console server 200 is shown. The console server 200 includes at least one port 210. In an example, the port 210 is a serial port, such as an RS232, RS 422 or RS 485 port. In another example, the port is a network port, and the console server communicates over a network through a virtual serial port. In an example, the port includes an on/off switch that allows automatic device detection or recognition to be turned on and off. In an example, the port also includes an on/off switch that allows automatic updating of the port name to be turned on and off. In an example, the switch that allows automatic updating of the port name can only be turned on when the port that allows automatic device recognition is turned on.

The console server 200 also includes a network connection 220. In an example, the network connection is an Ethernet port. In another example, the network connection is another network device, such as a wireless network connection or a modem. In an example, the console server includes a PCMCIA card slot to which a network device is attached or attachable. In an example, the network connection 220 couples the console server to a TCP/IP network, the internet, or a dial-up modem connection. In an example, communications with the console server are encrypted to provide secure access to a server. The network connection 220 is connected to the Processor Circuit 230. The port 210 is accessible through the network connection through the Processor Unit. In an example, a server connected to the port 210 is accessible by a computer that is coupled to the network connection.

The console server 200 also includes a processor circuit 230 that is connected to the port 210. In an example, the processor circuit 230 includes an integrated circuit on a chip. The console server 200 also includes a memory circuit 240 that is connected to the processor circuit 230. In an example, the memory circuit includes a RAM chip. In another example, the memory circuit includes a flash memory chip and flash memory card.

FIG. 3 is a schematic illustration of a console server 320 and several components connected to the console server. A terminal 300 is connected to the console server 320 through a network 310. In an example, the terminal 300 is a thin client, a personal computer such as a WINDOWS or Linux machine, or a workstation. In an example, the network 310 includes a TCP/IP network, a wireless network, the internet, and/or a dial-up connection. The console server 320 includes a plurality of ports 325, 326, 327, 328, 329 that connect devices such as servers or network gear to the console server. In some examples, the console server includes 16, 32, 48, or 64 ports. In other examples, the console server includes more or fewer ports. In the example shown in FIG. 3, port 325 is connected to a WINDOWS server 330. Port 326 is connected to a Linux server 340. Port 327 is connected to a router and firewall 350. Port 328 is connected to a DNS server 360. Port 329 is connected to a private branch exchange (PBX).

FIG. 4 is a schematic illustration of another example method 400. At 410, a processor examines information received from device through a port to determine whether the information about the operating system is incomplete. For example, some operating systems, such as WINDOWS 2003, provide a limited response to a probing character or string, and a particular probing string causes the device to send more complete information that includes, for example, server name, revision level, and/or patch level. In another example, information in the port log about an operating system is incomplete, and a probing character or sequence is sent to obtain further information. Returning to FIG. 4, if the information about the operating system running on the device is incomplete, or alternatively if a particular operating system is running on the device and known to provide incomplete information (e.g. WINDOWS 2003), at 420, a probing character or probing sequence associated with the operating system is sent through the port to the device. At 430, a response to the probe character or sequence is received through the port. At 440, the response is analyzed to determine information about the operating system running on the device, such as a server name, operating system revision level and/or operating system patch level. At 450, one or more port settings associated with the information determined from the response is selected. At 460, the one or more settings are applied to the port. In an example, the port is also named to convey information about the operating system running on the device connected to the port.

An example “active” device recognition method 500 is illustrated in the flow chart provided in FIG. 5. At 510, a console server optionally determines whether a port is in use. At 520, a probing character or probing sequence is sent through the port. In an example, the probing character is an Enter (CR=0x0d). At 530, a response to the probing character or probing sequence is received through the port. At 540, the response is analyzed to determine information about the device, such as the operating system and/or the assigned name (hostname) of the device connected to the port. At 550, a name is assigned to the port using information determined form the response. In an example, the name includes information about the device, such as the hostname and/or the operating system. At 560, a profile is selected using the information about the device determine from the response. In an example, a profile associated with the device name is selected. In another example, a profile associated with the operating system, a device type (e.g. SUN), or a device location is selected. In some examples, the profile is selected based upon a combination of the device name, device type, operating system, device location, or other device characteristics. At 570, settings are applied. In an example, the settings are specified by the profile. At 580, information is propagated to a master console server. At 590, the console server waits a specified period of time (e.g. five minutes), and then returns to 510 or 520, at which point a probing character is again sent through the port.

FIG. 6 provides a flow chart that illustrates another example method 600. At 610, a first set of data is acquired from a device connected to a first port on a console server. In an example, the first set of data is a boot sequence recorded in a port log. In another example, the first set of data is a response to a probing character or sequence. At 620, information about the device including, for example, the identity of the device, is determined from the first set of data acquired from the device. In an example, the identity of the device includes the device type (e.g. SUN), the assigned name (hostname) of the device, and/or the operating system that is running on the device. At 630, information about port settings applied to the first port is stored in a memory circuit. In an example, a new profile is generated for the device. At operation 640, the console server recognizes the device when it is reconnected to a different second port on the console server. In an example, the console passively recognizes the device by examining a port log for the second port. In another example, the console server actively recognizes the device by sending a probing character or sequence (probe string) and analyzing the response from the device connected to the port. At 650, information about the port settings applied to the first port is retrieved from the memory circuit. In an example, a new template created by the console server is retrieved from the memory circuit. At 660, at least one of port setting is applied to the second port. In an example, the at least one port setting applied to the second port is determined from the information about the port setting retrieved from the memory circuit. In an example, the at least one port setting applied to the second port is specified by a profile. In an example, the at least one port setting applied to the second port is the same as a port setting applied to the first port.

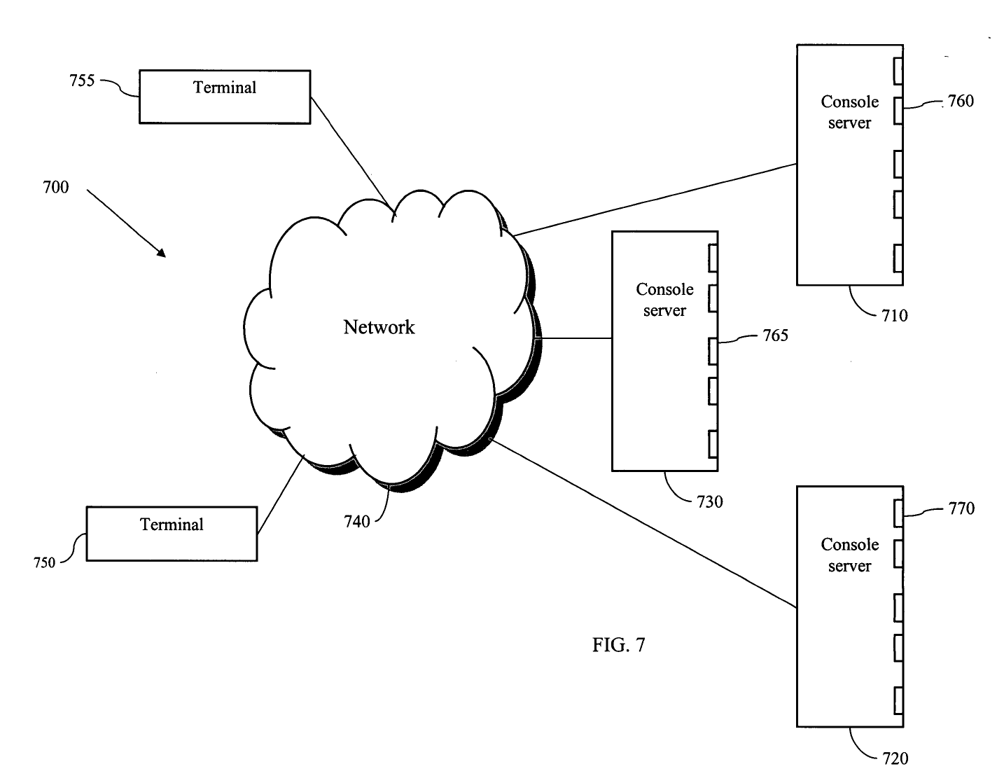

FIG. 7 shows a system 700 that includes plurality of console servers 710, 720, 730 connected to a network 740. In an example, information about port settings is transferred between or among console servers. In an example, a device is connected to a port 760 on a console 710, and a profile is generated for the device. The profile is transmitted to a second console serve 720. If the device is recognized at a port 770 on the second console server 720, port settings are applied to the port 770 on the second console server 720 using a profile or other information about the port settings obtained from the first console server.

In another example, a console server 730 is a master console server, and other console servers 710, 720 are slave console servers. A profile or other information about port settings for a device is transferred from a first server 710 to the master console 730, and is then transmitted to the other slave console server 720. When a device is disconnected from slave console server 710 and reconnected to master console server 730 or slave console server 720, port settings are applied to the port to which the device is connected using the information about the port settings applied on the first console server. In an example, the port settings on the first console server 710 are set manually by a human administrator. Transferring the settings to other console servers allows a port to which the device is connected to be configured by the console server without further input from a human administrator. In another example, port settings associated with an operating system, a device model and/or device type are transferred between or among console servers. When another device of the same device model or type or running the same operating system is recognized, port settings are applied using information about the port settings applied on the first console server.

Example Settings

Example ports include a variety of settings, such as host mode settings, serial settings, port logging settings, port event handling settings, IP filtering settings, authentication settings, user access rights, alert configurations, and power control settings. In an example, a profile associated with a device, device model, device type, and/or operating system includes one or more of these example settings.

Host Mode Settings

Some example ports include a variety of host mode settings. An Activate MICROSOFT WINDOWS SERVER 2003 Web-UI setting or an Activate Rackable System Management Board Web-UI setting allows a user interface to be launched. An IP Address Per Port setting controls the number and type of IP addresses assignable to the port. A Protocol setting sets protocols such as telnet, secure shell (ssh), or raw. A Port Escape Sequence (ˆz) setting allows definition of a character sequence to reach an escape menu. A Port Break Sequence setting allows definition of the sequence to send a serial break signal. An Inactivity Timeout setting provides for disconnection after an amount of time, which is optionally specifiable.

Serial Settings

Serial settings include, for example, data transfer rate, data bits, parity, stop bits, flow control, and DTR (data terminal ready) behavior.

Port Logging

Port logging settings include, for example, an Enable/Disable setting and a Logging Direction setting (e.g. unidirectional from a connected device or bidirectional). A Port Log Storage setting allows specification of the type of storage, e.g. local RAM, NFS server, or compact flash (CF). Other settings include syslog support, port-log size, port-log filename, timestamp (e.g. whether every message is time stamped), and Strip ˆM (to strip ˆM commands) settings.

Port Event Handling

Port event handling settings include, for example, a Keyword setting and an Email Notification setting. The Email Notification setting determines, for example, the title and recipient of an alert. In an example, when a device from a particular source (e.g. CISCO) is connected to a port, an alert message is sent to appropriate recipients associated with the source (e.g. CISCO operators.)

An SNMP (simple network management protocol) trap setting determines the recipient of SNMP traps.

User Access

An example User Access setting controls the access or level of access by users. In an example, user access is configurable according to operating system, so that particular users have access only to devices having specified operating systems. In another example, user access is configurable by device. Other examples include Read only, Read-write, and Power control settings.

Alert Configuration

Alert configuration settings control, for example, the generation of an alert message when a device is unplugged from a port or if a user logs into a port. In an example, alerts settings allow for sending an alert message via email or SNMP.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computer-implemented method comprising:
recording in a port log information received through a port on a console server from a device that is communicatively coupled to the port; and
executing instructions that read the information in the port log and determine an assigned name of the device and an operating system that is running on the device from the information in the port log.

2. The method of claim 1, wherein executing instructions includes executing instructions that analyze a boot sequence in the port log.

3. The method of claim 1, wherein executing instructions includes executing instructions that apply settings to the port, the settings associated with one or more characteristics of the device communicatively coupled to the port or the operating system that is running on the device.

4. The method of claim 3, wherein executing instructions includes executing instructions that retrieve information about the settings for a previous port to which the device was communicatively coupled, and apply settings to the port based upon the information about the settings for the previous port.

5. The method of claim 1, wherein executing instructions includes:
sending a probing transmission through the port, the probing transmission associated with the operating system that is running on the device communicatively coupled to the port;
receiving a response to the probing transmission;
determining information about the operating system from the response to the probing transmission;
identifying a profile that is associated with information determined from the response to the probing transmission, the profile specifying port settings; and
applying to the port the settings specified by the profile.

6. A method comprising:
determining an operating system running on a device communicatively coupled to a port of a console server;
sending a probing transmission associated with the operating system through the port;
receiving a response to the probing transmission;
determining information about the operating system from the response to the probing transmission;
identifying at least one port setting that is a function of at least one aspect of the information about the operating system determined from the response to the probing transmission; and
applying at least one port setting to the port.

7. The method of claim 6, wherein identifying at least one port setting that is a function of at least one aspect of the information about the operating system determined from the response to the probing transmission includes identifying a profile that is associated with information about the operating system determined from the response to the probing transmission, the profile specifying port settings; and
applying the at least one port setting to the port includes applying to the port the settings specified by the profile.

8. The method of claim 6, wherein determining an operating system running on a device communicatively coupled to a port of a console server includes recording in a port log information received through the port from the device that is communicatively coupled to the port, and analyzing the information in the port log.

9. The method of claim 6, wherein determining an operating system running on a device communicatively coupled to a port of a console server includes:
sending an initial probing transmission through the port;
receiving from the device communicatively coupled to the port on a console server port a response to the initial probing transmission; and
determining the operating system from the response to the initial probing transmission.

10. The method of claim 6, wherein determining an operating system running on a device communicatively coupled to a port of a console server includes analyzing information sent from the device in response to a probing character or string, the information sent from the device providing an incomplete description of the operating system.

11. The method of claim 6, wherein determining information about the operating system from the response to the second probing transmission includes determining the server name.

12. A console server comprising:
a port connectable to a device through a serial connection;
a network connection in communication with the port, wherein a device communicatively coupled to the port is accessible through the network connection; a processor circuit in communication with the port; and
a memory circuit embodying executable instructions operable on by the processor, including instructions that acquire information from a device communicatively coupled to the port during a device boot sequence, determine information about the device from the information acquired from the device, and apply settings to the port based upon the information determined about the device.

13. The console server of claim 12, wherein the instructions that acquire information from a device communicatively coupled to the port include instructions that record in a port log information sent through port on the console server, and the executable instructions that determine information about the device include instructions that determine from the information in the port log the assigned name of the device communicatively coupled to the port and the operating system that is running on the device.

14. The console server of claim 12, wherein the executable instructions include instructions that:
send a probing transmission through the port to the device communicatively coupled to the port, at least a part of the probing transmission a function of an aspect of the information acquired during the boot sequence,
receive a response to the probing transmission from the device through the port; and
determine further information about the device from the response to the probing transmission.

15. The console server of claim 14, wherein the executable instructions include instructions that identify a profile that is associated with information determined from the response to the probing transmission, the profile specifying port settings; and apply to the port the settings specified by the profile.

16. The console server of claim 14, wherein the executable instructions that determine information about the device include instructions that determine information about the operating system;
the instructions that send a probing transmission include instructions that send a probing transmission associated with at least one aspect of the information about the operating system; and
the instructions that determine further information about the device from the response to the probing transmission include instructions that determine further information about the operating system running on the device.

17. A computer-implemented method comprising:
acquiring from a device communicatively coupled to a first port on a console server port a first set of data;
determining from the first set of data information about the device including the identity of the device;
storing in a memory circuit information about port settings applied to the first port;
if the device is disconnected from the first port and communicatively coupled to a second port on the console server:
acquiring from the device through the second port a second set of data;
determining from the second set of data information about the device including the identity of the device, wherein the connection of the device to the second port is automatically recognized;
retrieving from the memory circuit the information about the port settings applied to the first port; and
applying to the second port at least one of the port settings applied to the first port, wherein the second port is automatically configured for communication with the device.

18. The method of claim 17, wherein acquiring from a device communicatively coupled to a first port on a console server port a first set of data includes recording in a port log data received through the first port; and
wherein determining from the first set of data information about the device includes determining information about the device from the data in the port log.

19. The method of claim 17, wherein acquiring from a device communicatively coupled to a first port on a console server port a first set of data includes sending a first probing transmission through the first port, and receiving a response to the first probing transmission from the device communicatively coupled to the first port.

20. The method of claim 19, wherein acquiring from a device communicatively coupled to a first port on a console server port a first set of data includes periodically sending a probing transmission through the first port and receiving a response, wherein the first port is periodically monitored for connection of a new device to the first port.

21. The method of claim 19, wherein:
determining from the first set of data information about the device includes determining an operating system running on the device;
acquiring from a device communicatively coupled to a first port on a console server port a first set of data further includes sending through the first port a second probing transmission associated with at least one aspect of information about the operating system determined from the response to the first probing transmission, and receiving a response to the second probing transmission; and
determining from the first set of data information about the device further includes determining information about the operating system from the response to the second probing transmission.

22. The method of claim 21, wherein storing in a memory circuit information about the port settings applied to the first port includes storing a profile that is associated with at least one aspect of the information determined from the response to the second probing transmission, the profile including port settings; and applying to the second port at least one of the port settings applied to the first port includes applying to the second port the settings specified by the profile.

23. The method of claim 17, wherein determining from the first set of data information about the device includes determining from the first set of data a location of the device communicatively coupled to the first port, and storing in a memory circuit information about port settings includes storing the location of the device.

24. The method of claim 17, wherein determining from the first set of data information about the device includes determining an assigned name of the device and an operating system that is running on the device.

25. The method of claim 24, wherein storing in a memory circuit information about port settings applied to the first port includes assigning a name to the first port, the assigned name including information that identifies the assigned name of the device that is communicatively coupled to the port and the operating system that is running on the device that is communicatively coupled to the port, wherein information about the device is identifiable from the name assigned to the port to which the device is communicatively coupled.

26. The method of claim 17, further comprising transmitting information about the port settings applied to the first port to a second console server, and, if the device is recognized at a second port on the second console server, applying to the second port at least one of the port settings applied to the first port, wherein the second port is automatically configured for communication with the device by the second console server.

27. The method of claim 26, wherein transmitting information about the port settings applied to the first port to a second console server includes transmitting the information about the port settings to a master console server and then transmitting the information about the port settings from the master console server to the second console server.
